(19) United States
(12) Patent Application Publication
(10) Pub. No.: US 2019/0040282 A1
(43) Pub. Date: Feb. 7, 2019

(54) INCREASING THE PULL-OFF FORCE BY SELECTIVE PLASMA PRETREATMENT

(71) Applicant: TESA SE, Norderstedt (DE)

(72) Inventors: Marcel HÄHNEL, Klein Nordende (DE); Sarah REICH, Hamburg (DE)

(21) Appl. No.: 16/078,492

(22) PCT Filed: Feb. 22, 2017
(86) PCT No.: PCT/EP2017/054032

§ 371 Date: Aug. 21, 2018

(30) Foreign Application Priority Data
Mar. 2, 2016 (DE) 10 2016 203 413.8

(51) Int. Cl. C09J 5/02; C09J 7/20

(52) U.S. Cl. CPC C09J 5/02; C09J 7/203

(57) ABSTRACT

The invention relates to a method for bonding an adhesive layer (3) with a first joining part (4), in which a first surface (3a) of the adhesive layer (3) is applied to a first joining part surface (4a) and the first surface (3a) of the adhesive layer (3) and/or the first joining part surface (4a) is/are subjected to partial area pre-treatment, a separating force in pre-treated areas (6) between the first joining part surface (4a) and the first surface (3a) of the adhesive layer (3) is increased thereby, and on peeling of the adhesive layer (3) from the first joining part surface (4a), the adhesive layer (3) separates cohesively in pre-treated areas (6) and the first surface (3a) of the adhesive layer (3) separates adhesively from the first joining part surface (4a) is untreated areas (7).

The invention relates to a method for bonding an adhesive layer with a joining part surface. The invention also relates to a component with a first joining part surface and a second joining part surface, both of which are bonded to each other with an adhesive layer.

An increase in the anchoring forces of adhesive tape products on substrates and in internal production processes can be achieved by the use of primers and physical pre-treatment methods and by combining such methods. These methods have generally been established for some time and are in use.

According to the prior art, an effort is made to subject surfaces to full-area, homogeneous pre-treatment so that uniform bonding or printing can be achieved in all areas.

Customers demand specified levels of adhesive force, and often cohesive failure of the adhesive tape product. In the case of optimal anchoring, according to conventional understanding, all of the surfaces involved are homogeneously prepared for bonding by means of corresponding pre-treatment in order to achieve the most favourable anchoring values possible. In addition to this, surfaces can be pre-treated with plasmas in a selective and structured manner in the micrometre range according to the prior art. In this case, the applications are in the printing field, with a particular focus on wet chemical metallization (cf. “Plasma Printing and Related Techniques—Patterning of Surfaces Using Microplasmas at Atmospheric Pressure” in Plasma Process. Polym., 2012, 9, 1086-1103).

The object of the present invention is to provide a method for bonding an adhesive layer to a joining part surface, by means of which the separating force between the adhesive layer and the joining part surface is greater than the separating force on full-surface homogenous cohesive failure of the bond. Another object of the invention is to provide a component with an adhesive bond that has high separating forces.

The object is achieved in its first aspect by a method mentioned above in which a first adhesive layer surface is applied to a first joining part surface and the first adhesive layer surface and/or the first joining part surface are subjected to partial area pre-treatment. The term “partial area” is to be understood here in a very general manner; this is a non-homogenous or structured pre-treatment that involves a random, homogeneously structured or patterned structure and/or a non-homogenous structure, wherein the structure can constantly repeat itself in a successive manner.

However, an essential feature of the invention is that the two first or one of the two first surfaces are treated only in certain areas. Regardless of the pre-treatment of the surface, however, the layer structure of the first joining part surface and the adhesive layer glued thereto is homogenous over the entire extension of the bond, i.e. identical everywhere. Because of the non-homogeneous pre-treatment of the first adhesive layer surface and/or the first joining part surface, if one skillfully selects the type of pre-treatment, as well as the adhesive substance and the material of the joining part surface, one achieves an enlarged breaking surface over the bonding surface and thus increased separating forces compared to homogenous full-surface pre-treatment.

Here, a joining part surface is generally understood to be a substrate surface. The substrate can be a flexible or solid substrate. It can also be a paint layer or a plastic layer. However, it can also be a bodywork component from the field of automotive construction. The joining part can in turn have a coated or uncoated configuration.

Over the pre-treated areas of the bonding surface, the adhesive bond preferably breaks cohesively, i.e. the adhesive bond breaks along the adhesive layer because the separating forces between the first adhesive layer surface and the first joining part surface are elevated compared to the separating forces of the untreated bond between the first adhesive layer surface and the first joining part surface. In contrast, the adhesive bond over the untreated areas along the bonding surface between the first adhesive layer surface and the first joining part surface fails.

The adhesive layer is preferably a component of an adhesive tape. The adhesive tape preferably comprises a carrier film on one side of which the adhesive layer is applied. However, it is also conceivable that the adhesive layer itself is strong enough that one can dispense with a carrier film.

In addition, however, the adhesive layer surface also breaks transversely, preferably perpendicularly to the bonding surface and/or the first adhesive layer surface and the first joining part surface between the area of cohesive and the area of adhesive failure so that a part of the adhesive substance layer that adheres to a carrier film can be peeled off the joining part surface. The regional adhesive and cohesive failure of the adhesive bond gives rise to an enlarged breaking surface, which as a whole results in a greater separating force between the detached part of the adhesive layer and the joining part surface.

Preferably, a second surface of the adhesive layer is applied to a second joining part surface. Advantageously, the adhesive layer is provided in the form of an adhesive tape. The adhesive tape comprises an adhesive layer and a carrier film. The first surface of the adhesive layer is arranged opposite the carrier film. On bonding together of the two joining parts at the first joining part surface and the second joining part surface by means of the adhesive layer, the first adhesive layer surface is first glued to the first joining part surface of the first joining part, after which the peel-off film is peeled from the second surface of the adhesive layer and the second joining part surface of the second joining part is glued to the second adhesive layer surface. This gives rise to an adhesive bond between the first joining part surface and the second joining part surface caused by the adhesive substance. The first joining part surface is preferably a surface of a first joining part that is provided such that it can be moved by itself and independently of a second joining part, with said second joining part having a second joining part surface. In other embodiments, however, it is also conceivable for the first joining part surface and the second joining part surface to be surfaces of the same joining part.

Advantageously, pre-treatment of the surface of the adhesive layer and/or the joining part surface is carried out by primer application or by means of a plasma pre-treatment.

The primer can be applied to the first joining part surface and/or the first adhesive layer surface by conventional methods such as spraying, painting, or application with a doctor blade. In this case, primer structures can be applied to the surfaces in almost any desired form. Preferably, the smallest distances between the pre-treated areas of the surfaces are between 1 and 10 μm, particularly preferably between 1 and 2 μm.

In another embodiment of the method according to the invention, the surfaces are subjected to plasma or corona pre-treatment. Plasma or corona pre-treatment of the surfaces causes them to be activated. Activation of the surfaces and subsequent application of an adhesive substance to the activated surface increases the separating force compared to the unactivated surface. Advantageously, however, the surface is not subjected to full-surface treatment and plasma activation, but can also be subjected to partial surface activation, wherein the activation can be carried out according to a predetermined repeating pattern, e.g. by means of a plasma source or masking templates.

Under certain circumstances, plasma sources can also give rise to non-homogeneous treatments. This is possible in particular in the case of filamentary discharges or discharges having sharply differing field regions. In this case, with certain process configurations, it is possible to carry out non-homogeneous treatments by suitably selecting a higher web speed of the material to be treated with simultaneously low plasma power.

In a particularly expedient and preferred embodiment of the method according to the invention, the plasma and primer pre-treatment are combined, i.e., preferably by first subjecting the surface to partial area pre-treatment using plasma and then applying a primer to the areas of the surface subjected to partial area pre-treatment, wherein because of the plasma pre-treatment, the primer is glued onto the joining part surface with an increased separating force.

The invention is also achieved by means of a component as described above, characterized according to the invention in that a separating force between the two joining part surfaces is greater than a separating force of the adhesive bond of the two joining part surfaces that suffers full-surface cohesive failure.

The invention will be described by means of examples with reference to six figures. The figures are as follows:

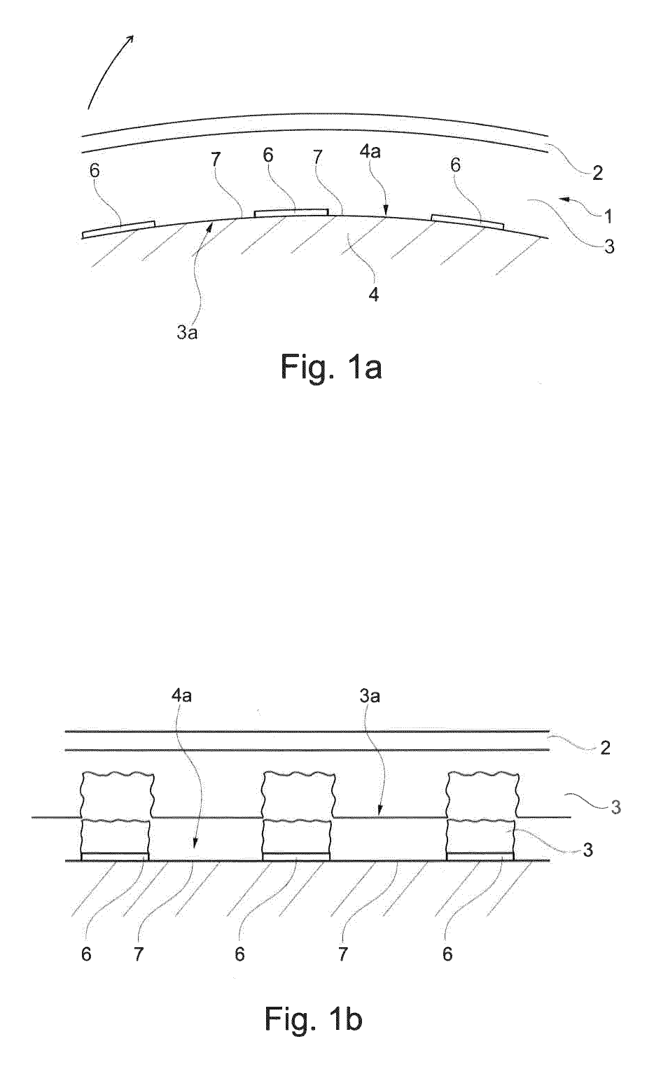

FIG. 1a, FIG. 1b side view of a bond according to the invention between an adhesive tape and a first joining part surface in a closed and open state,

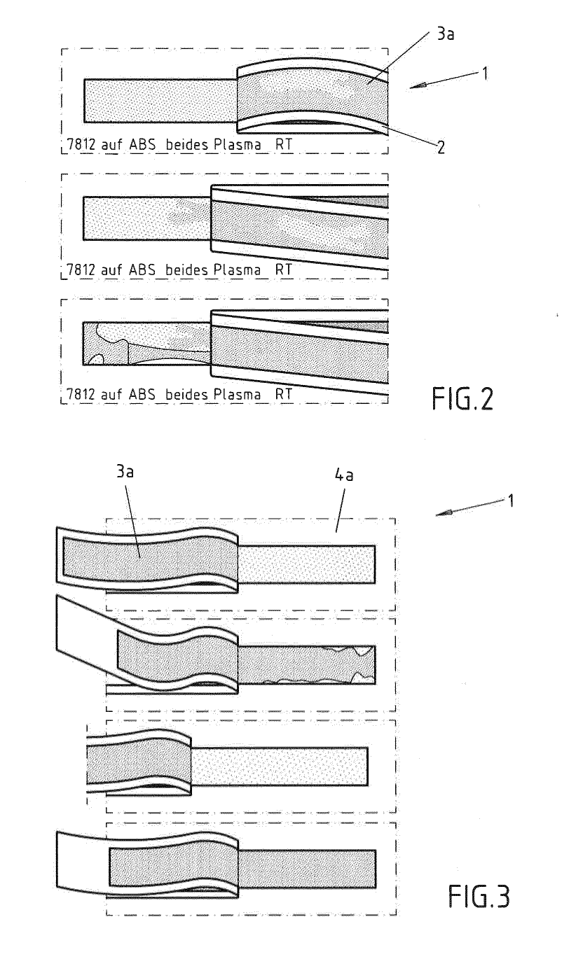

FIG. 2 three photos of tesa® 7812 on ABS after plasma pre-treatment of an adhesive substance and the ABS surface,

FIG. 3 breaking images of tesa® 7812 on automobile paint on untreated surfaces when plasma pre-treatment is carried out only on the first surface of the adhesive substance layer, only on the paint surface, (AS WELL AS) on both the first surface of the adhesive layer and the paint surface,

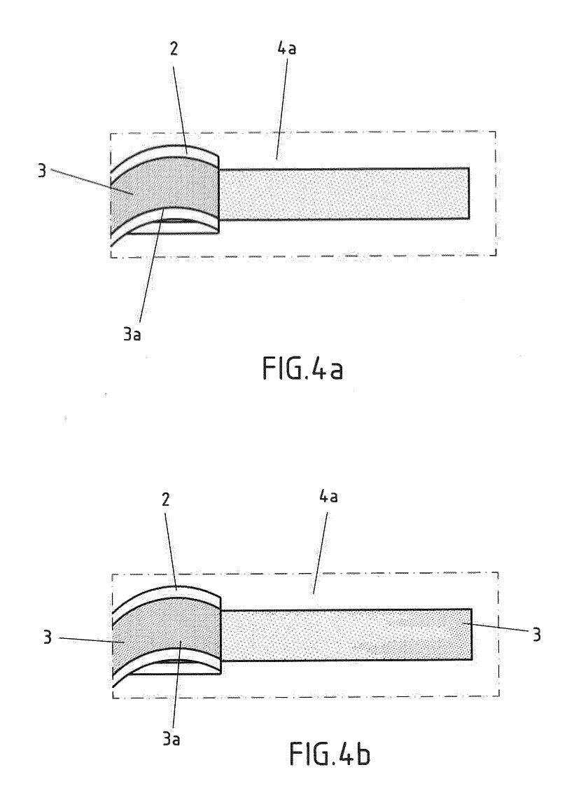

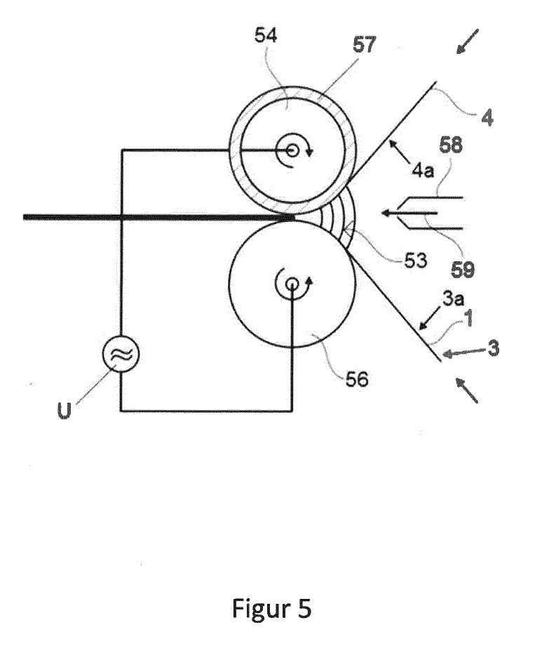

FIG. 4a, FIG. 4b photos of an opened adhesive tape with the adhesive substance tesa 707x Core on Cello 33.13 after plasma lamination,

FIG. 5 representation of the functional principle of plasma laminating.

FIG. 1a shows a diagram illustrating the principle of the structure of an adhesive bond according to the invention between an adhesive tape 1, which comprises a carrier film 2 and an adhesive layer 3, wherein a first adhesive layer surface 3a of the adhesive layer 3 is arranged on the side of the adhesive layer 3 facing away from the carrier film 2 and the first surface 3a of the adhesive layer 3 is designed to be glued onto a first joining part surface 4a of a first joining part 4. FIG. 1a shows the surface after it has been glued on.

The free first adhesive layer surface 3a of the adhesive tape 1 is initially free. The adhesive tape 1 is then glued onto the first joining part surface 4a with its first adhesive layer surface 3a.

The bond between the first adhesive layer surface 3a and the first joining part surface 4a is subjected to pre-treatment in which either the first adhesive layer surface 3a or the first joining part surface 4a or both are or have been pre-treated.

As a rule, the pre-treatment is a partial area pre-treatment. It can preferably be a partial area application of a primer to the first adhesive layer surface 3a or the first joining part surface 4a or both, but also a partial area plasma pre-treatment either of the first adhesive layer surface 3a or the first joining part surface 4a or both of the surfaces 3a, 4a.

Here, partial area pre-treatment means that the respective surface is not treated over its entire area, i.e. the entire extension of the surface, but only partially, i.e. in pre-treated areas 6 of the surface. The pre-treated areas 6 can be individually distributed or contiguously configured and/or have any desired peripheral shape.

The pre-treated areas 6 can be distributed on the surface contiguously or separated from one another. The surface pre-treatment preferably has a reproducible structure. A predetermined, reproducible structure can be achieved for example by application of a stamp that leaves the pre-treated areas 6 exposed to plasma pre-treatment uncovered and covers the untreated areas 7 that are configured to be complementary to the pre-treated areas 6 and are not subjected to plasma pre-treatment. For this purpose, for example, gas is conducted through tubes into areas of a stamp, with said gas regionally activating the surface as a process gas. The die and the surface are exposed as poles to a high-frequency alternating electric field. Such a die is described for example in “Plasma Printing and Related Techniques—Patterning of Surfaces Using Microplasmas at Atmospheric Pressure,” in Plasma Process. Polym. 2012, 9, 1086-1103, FIG. 4 on pg. 1,091. However, other methods for applying a specifiable plasma-pre-treated structure to a surface, which are described in said article, are also conceivable.

In pre-treatment by means of primer application, the structure can also be produced and applied over a partial surface by means of lithographic methods.

Preferably, pre-treatment of the adhesive bond is carried out only on the first joining part surface 4a. Alternatively, the adhesive layer surface of the adhesive tape can also be subjected to partial surface treatment, for example also by means of a plasma process or partial surface application of a primer.

FIG. 1b shows the state of the adhesive bond after the adhesive tape 1 has been peeled off the first joining part surface 4a.

In the plasma-pre-treated areas 6, the separating force is increased by the plasma pre-treatment between the first joining part surface 4a and the first adhesive layer surface 3a compared to the separating force between the untreated first joining part surface 4a and the first adhesive layer surface 3a.

According to the invention, the separating force is increased until it is greater than the cohesive strength of the adhesive layer 3, so that when the adhesive tape 1 over the pre-treated areas 6, which are pre-treated with plasma, is peeled off, cohesive breaking occurs inside the adhesive layer 1. Over the non-plasma-pre-treated areas 7, the separating force between the joining part surface 4a and the first adhesive layer surface 3a is less than the cohesive strength of the adhesive layer 1, so that when the adhesive tape 1 is peeled off the first joining part surface 4a in the non-plasma-pre-treated areas 7, the adhesive layer 3 immediately detaches again from the first joining part surface 4a.

FIG. 1b shows the differing breaking behaviour of the adhesive tape 1 over plasma-pre-treated areas 6 and non-plasma-pre-treated areas 7 of the first joining part surface 4a. It is essential to the invention that the differing height of the break line over the first joining part surface 4a on detachment of the adhesive tape 1 produces additional break lines that are perpendicular to the first joining part surface 4a inside the adhesive layer 3, so that the breaking surface is larger than in a full-surface cohesive failure or a full-surface adhesive failure. This enlargement of the breaking surface gives rise to the desired effect of even allowing the separating force between the carrier film 2 and the first joining part surface 4a, i.e. the force with which the carrier film 2 is peeled off the joining part surface 4a, to be greater than the separating force on full-surface cohesive failure of the adhesive layer 3.

FIG. 2 shows anchoring of tesa® ACXplus 7812 adhesive tape 1 to the first joining part surface 4a composed of ABS. In this case, the adhesive tape 1 is glued onto ABS, wherein ABS refers to acrylonitrile-butadiene-styrene. The tesa® ACXplus 7812 adhesive tape 1 is a dark black acrylic foam adhesive tape, and the adhesive layer is applied to a chemically-etched PET (polyethylene) stabilizing film, shown here as a transparent film.

In the three photos shown in FIG. 2, both the joining part surface 4a, i.e. the surface of the ABS substrate, and the first adhesive layer surface 3a of the tesa ACX 7812 adhesive layer 3 are subjected to plasma pre-treatment using a Piezobrush®. In FIG. 2, three tesa® ACXplus 7812 adhesive tapes 1 have been applied to the ABS joining part surface 4a. The plasma pre-treatment was carried out using a Piezobrush® plasma device.

The Piezobrush® from the firm Reylon Plasma GmbH, formerly Reinhausen Plasma GmbH, produces the plasma by means of a piezoelectric effect made possible by the opposite polarization directions of the crystal. As a result of this discharge technology, compared to use of an electrical arc, a cold, non-thermal plasma is generated. The temperatures are close to room temperature.

The principle of the piezo element is presented for example in EP 2168409 B1. Piezo elements are particularly suitable when used in combination with cooling devices provided thereon, allowing the plasma produced by the alternating electric field to be subsequently cooled, which in turn allows a so-called low-plasma-temperature plasma to be discharged from an outlet nozzle that is not explicitly shown.

The Piezobrush PZ2 produces a plasma with a plasma temperature of less than 50° C.

The Piezobrush PZ2 is guided at a distance of 5 mm-10 mm and a speed of up to 5 m per min over a substrate surface or an adhesive surface, thus preparing the surfaces for the gluing process.

Because of the low plasma temperature of less than 50° C., the same plasma source can be used both for pre-treatment of the joining part surface 4a and for pre-treatment of the adhesive layer surface 3a.

The Piezobrush® is a manual plasma device, but in this experiment it was mounted above a positioning table in order to achieve constant conditions during the treatment. The speed of the positioning table with the joining part 4 and the adhesive substance 3 was selected such that a speed of 5 m/min did not allow homogeneous treatment. This is shown in the three photos in FIG. 2. In all three cases, peel-off forces were tested by means of a 90° adhesive strength test, i.e. the reinforcing film was pulled off the ABS film at a 90° angle.

In the first case, i.e. the upper example in FIG. 2, the separating force measured was 66.2 N/cm, for the middle samples it was 88.47 N/cm, and for the lower example it was 92.93 N/cm. On full-surface cohesive failure in the middle of the product, the separating force is approx. 67 N/cm. This shows that in some cases, because of the partial area pre-treatment of the surfaces and the non-homogeneous breaking behaviour of the adhesive layer in FIG. 2, one can expect a significant increase in the separating forces compared to a full-surface cohesive failure.

FIG. 3 shows four further tests in each of which the tesa® ACXplus 7812 adhesive tape was applied to the automobile paint 2K-Klarlack Enhanced 540 from the firm Hemmelrath Lackfabrik GmbH and the surfaces were pre-treated using a plasma jet from the firm Plasmatreat.

The plasma jet functions according to a somewhat different principle of electrical field generation and is described for example in EP 0986939 A1. The gas flowing through the discharge chamber is ionized by the plasma. This plasma is then driven by the gas flow to the surface to be treated, where it in particular causes surface oxidation, thus improving the wettability of the surface. The type of physical pre-treatment is (in this case) referred to as indirect, because the pre-treatment is not carried out at the site where the electrical discharge is generated, as is the case for a corona discharge. The pre-treatment of the surface is carried out at or close to atmospheric pressure, wherein, however, the pressure in the electrical discharge chamber or gas channel can be elevated. In this case, the plasma is understood to be atmospheric pressure plasma, which is an electrically activated homogenous reactive gas that is not in thermal equilibrium, with a pressure close to ambient pressure in the operating area. As a rule, the pressure is 0.5 bar above ambient pressure. By means of the electrical discharges and ionizing processes in the electric field, the gas is activated, and highly-excited stages are produced in the gas components. The gas and the gas mixture used are referred to as process gas. Components of the atmospheric pressure plasma can be highly-excited atomic states, highly-excited molecular states, ions, electrons, or unchanged components of the process gas. The atmospheric pressure plasma is produced not in a vacuum, but ordinarily in an air environment. This means that if the process gas itself is not air, the outflowing plasma will at least contain components of the surrounding air.

In the first case, shown at top in FIG. 3, both the first adhesive layer surface 3a and the paint surface 4a are untreated. In the second case, the surface of the adhesive layer 3a is pre-treated with the plasma jet, in the third case, only the paint is pre-treated, and in the fourth case, both surfaces 3a, 4a are pre-treated with the plasma jet.

However, the measured separating forces are significantly lower, namely more than 20 N/cm lower in each case than in the partial adhesive failure shown in FIG. 2. The separating forces in uniform cohesive failure are thus lower than in partial cohesive failure.

FIGS. 4a and 4b also show a mixture of cohesive and adhesive failure of the adhesive bond between the adhesive tape 1 and the joining part surface 4a. As adhesive tape 1, a double-layer construction composed of an acrylate-based self-adhesive viscoelastic carrier material with an acrylate adhesive substance as a functional layer was used. The adhesive tape 1 was reinforced on both sides with a chemically-etched PET film for the T peel test. The described adhesive tape 1 was produced by plasma lamination, by means of which both the surface of the adhesive layer 3a and the surface of the carrier material 4a were subjected to extremely low-power plasma treatment.

The process of plasma lamination is characterized in that two surfaces to be laminated onto one another are pre-treated with plasma immediately before lamination, for example by pulling two films with two surfaces facing each other between two rollers rotating in opposite directions and directing a plasma jet onto the two surfaces, which are pulled apart, prior to lamination and pulling into the lamination gap.

FIG. 5 shows a lamination gap 53 formed by a pressure roller 54 and a counter-pressure roller 56, wherein said gap builds up the counter-pressure desired for lamination. The rollers 54, 56, which are equal in their diameters and their longitudinal extension along their axes of rotation, rotate in opposite directions at the same peripheral speed. A layer of a dielectric 57 is applied to the outside of the pressure roller 54, with said layer completely surrounding the periphery of the pressure roller 54 and being applied over the entire outer surface of the pressure roller 54 along the entire longitudinal extension of the pressure roller 54. The layer thickness of the dielectric 57 is preferably between 1 and 5 mm. The dielectric 57 is preferably composed of ceramic, glass, plastic, or rubbers such as styrene-butadiene rubbers, chloroprene rubbers, butadiene rubbers, acrylonitrile-butadiene rubbers, butyl rubbers, ethylene-propylene-diene rubbers (EPDM) or polyisoprene rubbers (IR).

Between the pressure roller 54 and the counter-pressure roller 56, a high-frequency alternating current is applied that produces a plasma in the lamination gap 53. A process gas 59 is supplied via a process gas nozzle 58 to the lamination gap 53; in various tests, air, nitrogen, or carbon dioxide was used as the process gas 59, but other process gases or mixtures of these process gases are also conceivable.

Plasma pre-treatment is carried out at a pressure close to atmospheric pressure, i.e. at atmospheric pressure±0.05 bar or at atmospheric pressure.

The carrier material 4 and the adhesive layer 3 are continuously supplied to the lamination gap 53 in the same web direction. The web speeds are 0.5 to 200 m/min, preferably 1 to 50 m/min, particularly preferably 2 to 20 m/min.

The first adhesive layer surface 3a and the first surface of the carrier material 4a are laminated together in the lamination gap 53, i.e. pressed together such that a laminate is produced that forms the adhesive tape 1. The two first surfaces 3a, 4a are arranged relative to one another such that during lamination, they are pressed against each another in direct contact with each other and under pressure. The two first surfaces 3a, 4a are subjected to full-surface plasma pre-treatment before being laminated together, specifically such that the plasma continuously acts on the two first surfaces beginning before the lamination gap 53 and continuing into the lamination gap 53.

The normal cohesive strength of the viscoelastic carrier material 3 is 18.3 N/cm, while the separating force on partial cohesive failure according to FIG. 4b is 18.9 N/cm. The separating force in FIG. 4a in another case of partial cohesive failure is 9/5 N/cm. Overall, the tests clearly showed that by means of surface pre-treatment, one can cause regional cohesive and regional adhesive failure or separation of the bond and that the separating forces of the adhesive bond can be greater than the separating forces of a full-surface cohesively failing adhesive bond.

### LIST OF REFERENCE NOS

1 Adhesive tape
2 Carrier film
3 Adhesive substance layer
3a Surface of the adhesive substance layer
4 Joining part/carrier material
4a Joining part surface
6 Pre-treated areas
7 Untreated areas
53 Lamination gap
54 Pressure roller
56 Counter-pressure roller
57 Dielectric
58 Process gas nozzle
59 Process gas

1. A method of bonding an adhesive layer with a first joining part, in which a first surface of the adhesive layer is applied to a first joining part surface and the first surface of the adhesive layer and/or the first joining part surface is/are subjected to partial area pre-treatment, a separating force in pre-treated areas between the first joining part surface and the first surface of the adhesive layer is increased thereby, and on peeling of the adhesive layer from the first joining part surface, the adhesive layer separates cohesively in pre-treated areas and the first surface of the adhesive layer separates adhesively from the first joining part surface in untreated areas.

2. The method of claim 1, wherein a second surface of the adhesive layer is applied to a second joining part surface.

3. The method of claim 1, wherein the first surface of the adhesive layer and/or the first joining part surface is/are pre-treated with a primer.

4. The method of claim 1, wherein the first surface of the adhesive layer and/or the first joining part surface is/are treated with a plasma.

5. The method of claim 4, wherein the plasma pre-treatment is carried out by a plasma printing process.

6. The method of claim 1, wherein the first surface of the adhesive layer and/or the first joining part surface is/are pre-treated with plasma in a predetermined pattern.

7. The method of claim 6, wherein the smallest distances between the areas of the pattern pre-treated with plasma (6) are between 1 and 10 μm.

8. The method of claim 1, wherein the first surface of the adhesive layer and/or the first joining part surface is/are first treated with plasma and the primer is then applied to the areas pre-treated with plasma.

9. The method of claim 1, wherein a separating force between the first surface of the adhesive layer and the first joining part surface is greater than a separating force on full-surface cohesive failure of the adhesive layer.

10. A component comprising a first joining part surface and a second joining part surface, both of which are bonded to each other with an adhesive layer, wherein a separating force between the two joining part surfaces is greater than a separating force of a full-surface cohesive failure of the adhesive layer.
